(19) United States
(12) Patent Application Publication
(10) Pub. No.: US 2022/0391971 A1
(43) Pub. Date: Dec. 8, 2022

(54) SYSTEM, METHOD, AND COMPUTER PROGRAM PRODUCT FOR IMPROVED ELECTRONIC AUCTION PLATFORM PERFORMANCE

(71) Applicant: KopenTech LLC, Los Angeles, CA (US)

(72) Inventors: Olga Chernova, New York, NY (US); James August Vogl, Los Angeles, CA (US); Anthony Schexnayder, Long Beach, CA (US); Anna Gryb, Los Angeles, CA (US); Alexander Gryb, Los Angeles, CA (US)

(21) Appl. No.: 17/829,240

(22) Filed: May 31, 2022

Related U.S. Application Data
(63) Continuation-in-part of application No. 16/820,349, filed on Mar. 16, 2020, now abandoned.
Application No. 16/820,349 is a continuation-in-part of application No. 16/799,736, filed on Feb. 24, 2020.
(60) Provisional application No. 63/195,120, filed on May 31, 2021.
(60) Provisional application No. 62/819,442, filed on Mar. 15, 2019.
(60) Provisional application No. 62/809,493, filed on Feb. 22, 2019.

(51) Int. Cl. G06Q 30/08

(52) U.S. Cl. CPC G06Q 30/08

(57) ABSTRACT

A method for hosting a multi-stage, token-gated electronic auction includes: during a blind-bidding period, receiving a set of blind bids from bidders on an electronic biding platform and obfuscating blind bid information of other bid from bidders for each blind bidder; after the blind-bidding period, selecting a subset of bidders equal to a live-bidder quantity and associated with blind bids of greatest value, generating a set of digital access tokens for live-bidding, and assigning the digital access tokens to the subset of bidders; and, during a subsequent live-bidding period, admitting the subset of bidders into a virtual private live-bidding room based on the digital access tokens, receiving live bids from the subset of bidders, publishing bid values of live bids received from other bidder for each live bidder, and obfuscating live bid information for bidders other than the subset of bidders.

### CROSS-REFERENCE TO RELATED APPLICATIONS

This claims the benefit of U.S. Provisional Application No. 63/195,120, filed on 31 May 2021, which is incorporated in its entirety by this reference.

This application is a continuation-in-part application of U.S. patent application Ser. No. 16/820,349, filed on 16 Mar. 2020, which claims the benefit of U.S. Provisional Patent Application No. 62/819,442, filed on 15 Mar. 2019, each of which is incorporated in its entirety by this reference.

This application is a continuation-in-part application of U.S. patent application Ser. No. 16/799,736, filed on 24 Feb. 2020, which claims the benefit of U.S. Provisional Patent Application No. 62/809,493, filed on 22 Feb. 2019, each of which is incorporated in its entirety by this reference.

### TECHNICAL FIELD

This invention relates generally to the field of networked computer systems and more specifically to a new and useful system, method, and computer program product for improved electronic auction platform performance in the field of electronic trading platforms.

### BRIEF DESCRIPTION OF THE FIGURES

FIG. 1 is a schematic representation of a computing device;

FIG. 2 is a schematic representation of an auction platform and associated operating environment;

FIGS. 3A and 3B are flowchart representations of a first method executable by the auction platform;

FIG. 4 is a flowchart representation of one variation of the first method executable by the auction platform;

FIG. 5 is a graphical representation of one variation of the first method executable by the auction platform; and

FIGS. 6A and 6B are a flowchart graphical representation of a second method executable by the auction platform.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

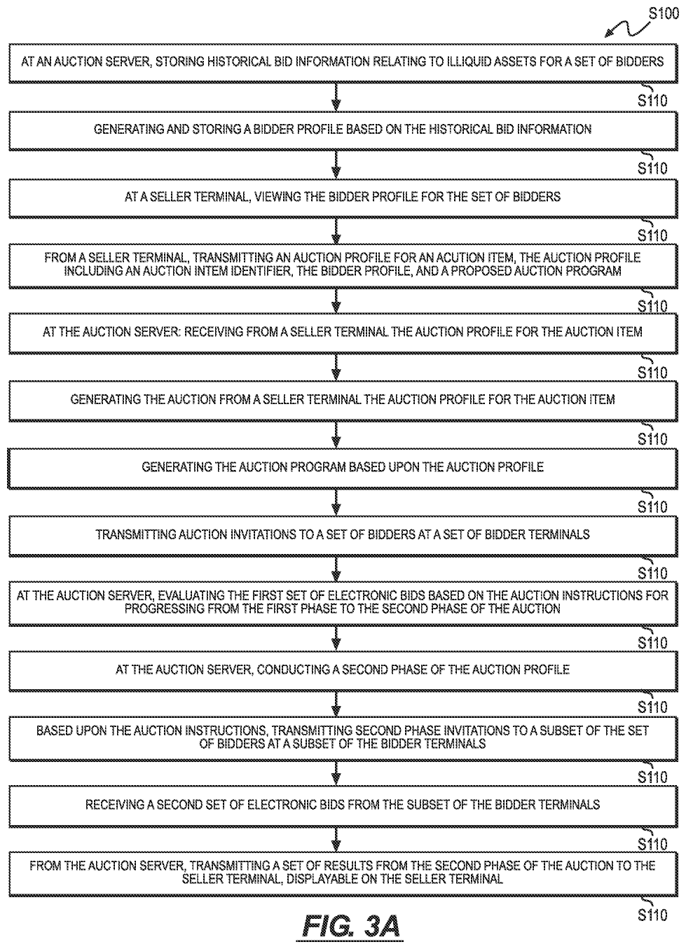

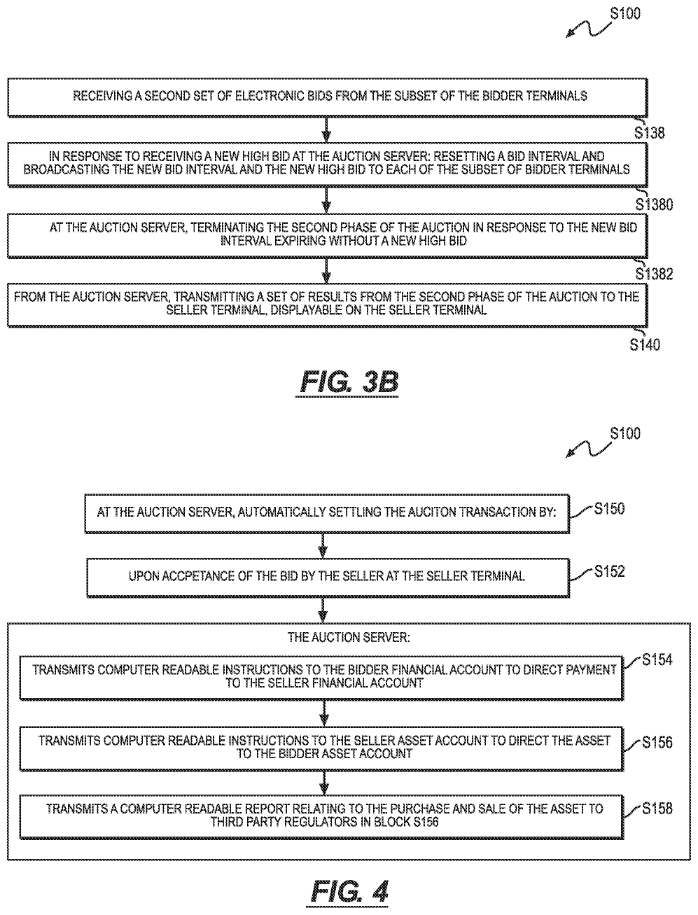

As shown in FIGS. 3A, 3B, and 4, a computer implemented first method S100 for improving computational efficiency in a network-based auction platform can include: at an auction server, storing historical bid information relating to illiquid assets for a set of bidders in Block S110 and generating and storing a bidder profile based on the historical bid information in Block S112. The first method S100 can also include, at a seller terminal, viewing the bidder profile for the set of bidders in Block S114 and, from a seller terminal, transmitting an auction profile for an auction item, the auction profile including an auction item identifier, the bidder profile, and a proposed auction program in Block S116.

The first method S100 can further include: at the auction server: receiving from a seller terminal the auction profile for the auction item in Block S120; generating the auction program based upon the auction profile in Block S122; and transmitting auction invitations to a set of bidders at a set of bidder terminals in Block S124. In one example implementation, the auction invitations include auction instructions for progressing from the first phase to the second phase of the auction, displayed on the bidder terminals: including incentives such as single best bid, limited access to second phase, limited information sharing between bidders, etc.

The first method S100 can further include, at the auction server, conducting a first phase of the auction profile by receiving a first set of electronic bids from the bidder terminals in Block S130; at the auction server, evaluating the first set of electronic bids based on the auction instructions for progressing from the first phase to the second phase of the auction in Block S132. The first method S100 can also include the auction server, conducting a second phase of the auction profile in Block S134 by: based upon the auction instructions, transmitting second phase invitations to a subset of the set of bidders at a subset of the bidder terminals in Block S136; receiving a second set of electronic bids from the subset of the bidder terminals in Block S138; from the auction server, transmitting a set of results from the second phase of the auction to the seller terminal, displayable on the seller terminal in Block S140.

In one variation of the example implementations shown in FIG. 3B, the first method S100 can further include: in response to receiving a new high bid at the auction server, resetting a bid interval and broadcasting (in real-time or substantially real-time) the new bid interval and the new high bid to each of the subset of bidder terminals in Block S1380. Furthermore, the first method S100 can also include at the auction server, terminating the second phase of the auction in response to the new bid interval expiring without a new high bid in Block S1382.

Generally, the auction server can conduct the second phase of the auction by transmitting or broadcasting to each of the selected bidder terminals a time interval (e.g., countdown clock for an auction phase) and a current high bid in real-time or substantially real-time, such that the subset of bidder terminals is receiving “live” updates regarding the state of the auction. During each time interval, the auction server can receive one or more bids transmitted from each of the subset of bidder terminals. Upon receipt of a new high bid, the auction server can reset the time interval (i.e., begin the countdown again) and broadcast the new high bid (and/or second, third place bids) to each of the subset of bidder terminals. Generally, the auction server can terminate the second phase of the auction when, at the end of the time interval, there are no new high bids, in which case the prevailing high bid from the prior time interval can be selected as the winning bid for the good or service.

In another variation of the example implementations shown in FIG. 4, the first method S100 can further include, at the auction server, automatically settling the auction transaction in Block S150. Upon acceptance of the bid by the seller at the seller terminal in Block S152 the auction server: transmits computer readable instructions to the bidder financial account to direct payment to the seller financial account in Block S154; transmits computer readable instructions to the seller asset account to direct the asset to the bidder asset account in Block S156; and transmits a computer readable report relating to the purchase and sale of the asset to third party regulators in Block S156.

### 1.1 Operating Environment

The first method S100 for improving computational efficiency in a network-based auction platform (“auction platform”) can improve performance of the auction platform and associated computing devices by increasing auction efficiency and reducing computational drag and bandwidth consumption on the auction platform. Typical online auction platforms and exchanges (e.g., securities or options exchanges) may provide online markets for the sale of purchase and assets but with substantial consumption of electrical power and a significant computational and networking burdens on disparate user terminals, servers, and associated hardware.

Generally, the auction platform can execute Blocks of the method to enable users of disparate computing devices to sell and purchase goods or services according to a prescribed auction format, which increases computational efficiencies through streamlined auction practices throughout the auction platform. In particular, the first method S100 can assist in the sale and purchase of illiquid assets (e.g., assets for which there is not readily available market pricing) such as antiques, art, certain non-fungible tokens (NFTs), selected types of non-exchange listed financial securities, or derivative assets of any of the foregoing.

The present invention can be embodied as a method, system, or computer program product. Accordingly, aspects of the invention can be implemented entirely in hardware, entirely in software (including firmware, resident software, micro-code, etc.), or in a combination of software and hardware. These implementations generally referred to herein as a “circuit,” “module,” or “system.” Furthermore, the present invention can be implemented as a computer program product on a computer-usable storage medium having computer-usable program code embodied in the medium.

For example, the method can be embodied in a computer-usable or computer-readable medium such as an electronic, magnetic, optical, electromagnetic, infrared, or semiconductor system, apparatus, or device. A non-exhaustive list of the computer-readable medium can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. A computer-usable or computer-readable medium can be any medium that can contain, store, communicate, or transport the program for use by or in connection with the instruction execution system, apparatus, or device.

Computer program code for carrying out operations of the present invention can be written in an object-oriented programming language such as Java, Smalltalk, C++ or the like. However, the computer program code for carrying out operations of the present invention can also be written in conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through a local area network (LAN) or a wide area network (WAN), or the connection can be made to an external computer (for example, through the internet using an Internet Service Provider).

Example implementations of the invention are described below with reference to flowchart illustrations and/or block diagrams of methods, apparatus (systems) and computer program products according to aspects of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Moreover, computer program instructions can also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

### 1.1.1 Computing Device

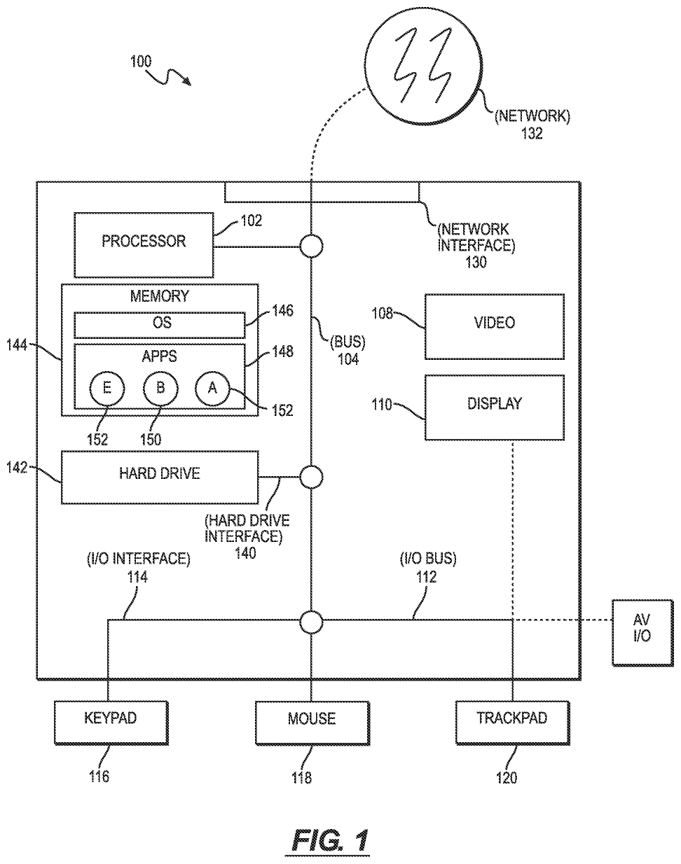

FIG. 1 is a block diagram of an exemplary computing device 100 in which the present invention can be utilized or implemented. Generally, the computing device 100 can include a processor 102. The processor 102 can be coupled to a system bus 104, which in turn can be coupled to a video adapter 108 and a display 110. Generally, the system bus 104 can be coupled to an Input/Output (I/O) bus 112, which in turn can be coupled to an I/O interface 114. The I/O interface 114 can facilitate wired or wireless communication with various I/O devices, including user interface (UI) devices such as a keyboard 116, a mouse 118, a trackpad 120, the display 110, speakers, microphones, etc.

Generally, the computing device 100 can include a network interface 130, which can be coupled to the system bus 104 and configured to connect the computing device 100 to a network 132. Generally, the network 132 can be an external network such as the internet, or an internal network such as a Virtual Private Network (VPN). Generally, the computing device 100 can utilize the network interface 130 and the network 130 to connect to, communicate with, and access data, software, or hardware assets (e.g., cloud computing or cloud storage services) on other computing devices 100 such as remote servers.

As shown in FIG. 1, the computing device 100 can also include a hard drive interface 140 that can interface with a hard drive 142. Generally, the hard drive 142 can read and write data to a system memory 144. Generally, the system memory 144 can include data such as the operating system (OS) 146 of the computing device 100 and software applications 148.

Generally, the software applications 148 can include a browser application 150 and email client 152. The browser application 150 and the email client 152 can include program modules and instructions enabling a client to send and receive network messages through the internet (e.g., through internet protocols), and communicate with one or more servers (e.g., web servers, email servers, etc.). Additionally, the software applications 148 can include an auction application 154 that can include software code for implementing the Blocks of the first method S100.

### 1.1.2 Auction Platform

As shown in FIG.. 2, an auction platform 200 can include an auction server 210, a set of user devices 220, including a set of bidder terminals 222 and a set of seller terminals 224, and a set of financial or regulatory servers 226.

Generally, the auction server 210 and the user device 220 can be configured as a computing device 100 of the type described above. Alternatively, the auction server 210 and the user device 220 can be configured as a set or plurality of networked computing devices 100 of the type described above that collectively function as a unitary computing device 100.

Generally, a user (e.g., a seller or a bidder) interacts with the auction server 210 via a user device 220 to purchase and sell goods or services through an auction format, particularly goods and services for which there is little liquidity. The user device 220 can include an information processing system such as a personal computer, a laptop computer, a tablet computer, a personal digital assistant (PDA), a smart phone, a mobile telephone, wearable computing device, or other device that is capable of communicating and processing data. The user device 220 can be configured to present, render, or display a user interface to a bidder or a seller, and generally the information that is presented, rendered, or displayed to the respective bidder or seller can be determined in accordance with the Blocks of the first method S100.

Generally, the user device 220 is used to exchange information between a seller and a set of bidders via the auction server 210. For example, the user device 220 can be used to configure an auction format at a seller terminal 224 and to submit electronic bids during the auction at the bidder terminal 222. Generally, communication between the user devices 220 and the auction server 210 is accomplished via a network 230, such as the internet, a physical private network, a wireless network, a virtual private network (VPN), or a combination thereof.

Generally, the auction server 210 can include an auction module 240 that interprets and implements instructions for conducting an online auction. Additionally, the auction server 210 can include a financial module 242 that can connect to and communicate with a set of financial institutions (via the financial and regulatory servers 226) for the seller and the set of bidders. The auction server 210 can also include a regulatory module 244 that can connect to and communicate with a set of regulatory institutions (via the financial and regulatory servers 226), including, for example, securities exchange regulatory servers, taxation regulatory servers, and other government or international finance, banking, or reporting servers.

### 1.2 Applications

Generally, the auction platform 200 executes Blocks of the method to form a globalized marketplace within an electronic or computer-based environment to enable the sale and purchase of goods and services, such as illiquid assets for which ascertainable market value is not readily available. The auction platform 200 can execute Blocks of the first method S100 to streamline the online auction process, reduce energy and bandwidth consumption by the auction platform environment, and increase transactional value of a good or service being auctioned.

Generally, the technology underlying online auctions promotes wasteful and inefficient usage of energy and bandwidth resources while also tending to yield fewer desirable outcomes for sellers and buyers. In particular, for markets in which there is little liquidity (e.g., no easily ascertainable market value akin to a constantly updated stock exchange or options exchange), there is a set of financial incentives in place that increase the overall strain on computing and network resources. That is, bidders are incentivized to obtain the lowest possible price for the goods or services, and therefore tend to bid low. In response, sellers are forced to extend the time of auction in order to drive up the bid prices, which in turn incentivizes more delay on behalf of the bidders; resulting in increased consumption of energy and bandwidth and the corresponding decline in computing and network performance for all computing devices associated with the auction.

Therefore, in other aspects of the present invention, the auction platform environment 200 can execute Blocks of the first method S100 to provide streamlined and efficient markets for illiquid securities (e.g., certain types of debt securities or tranches of debt securities) that would not otherwise be readily tradable in an online setting. In still other aspects of the present invention, the auction platform environment 200 can execute Blocks of the first method S100 to initiate, conduct, and settle an auction-based transaction for an illiquid asset in both an energy efficient and a bandwidth conserving manner while optimizing financial and computing outcomes for the parties involved.

### 1.3 Auction Construction

As shown in FIG. 3, a computer implemented first method S100 for improving computational efficiency in a network-based auction platform can include: at an auction server, storing historical bid information relating to illiquid assets for a set of bidders in Block S110, and generating and storing a bidder profile based on the historical bid information in Block S112. Generally, the auction platform 200 can execute Blocks S110 and S112 of the first method S100 by creating and storing a set of data relating to prior auction history for a set of bidders. In one example implementation, the prior auction history can include an auction history relating to certain types of illiquid assets (e.g., antiques, artwork, certain types of securities, certain types of financial derivatives, NFTs, etc.). Additionally, the auction platform 200 can execute Block S112 of the first method S100 by generating, for each bidder in a set of bidders, a profile based upon the auction history for each bidder including, for example, quantitative measures of the historical bidding performance of each bidder (e.g., high bids, low bids, total bids, bid improvements in an auction, bid improvements across multiple auctions, relative bid performance vis-à-vis other bidders in the set of bidders, normative bid performance vis-à-vis a normalized bidder profile, etc.).

As shown in FIG. 1, the first method S100 can also include, at a seller terminal, viewing the bidder profile for the set of bidders in Block S114 and from a seller terminal, transmitting an auction profile for an auction item, the auction profile including an auction item identifier, the bidder profile, and a proposed auction program in Block S116. Generally, the auction platform 200 can execute Blocks S114 and S116 of the first method S100 at the seller terminal 224 (e.g., a computing device 100 of the type described above) by: rendering and displaying the bidder profile generated at the auction server and accepting user input from the user (e.g., seller) regarding the item to be auctioned and associated information relating to user-specified parameters (e.g., auction duration, reserve prices, bidder pool, bidder selection process, auction format, etc.).

Generally, the seller terminal 224 can execute Block S116 of the first method S100 by receiving input from the seller regarding the auction profile based upon the bidder profile displayed on the seller terminal 224. The bidder profile can generally be customized or configured to represent bidder behaviors within a given set of auctions or asset types. In an example implementation of the first method S100, the type of auction is a securities auction (e.g., bid wanted in competition or “BWIC”), and the type of bidders are securities brokers, dealers, or investors. In other example implementations of the first method S100, the type of auction can be for other types of illiquid assets, such as fine art, antiques, collectible automobiles, NFTs, or real estate, and the type of bidders are collectors, auction houses, and investors.

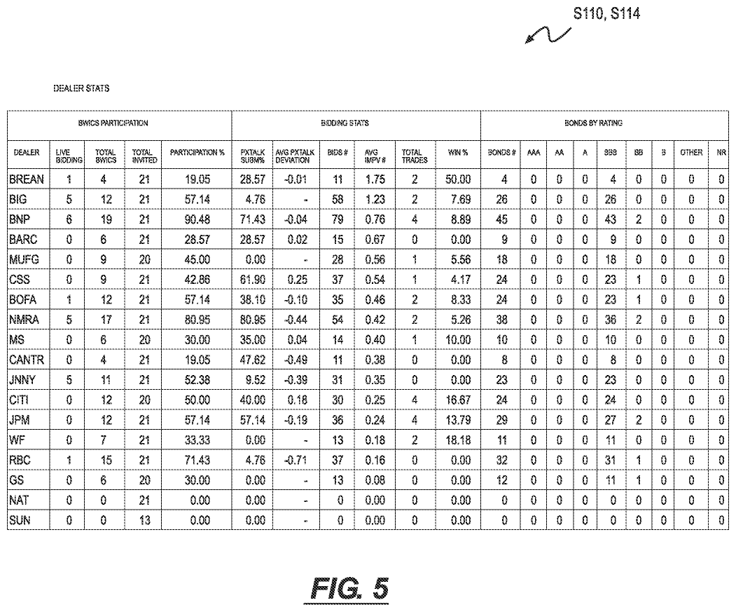

FIG. 5 is a graphical user interface representation of a bidder profile in accordance with one variation of the example first method S100. As shown in FIG. 4, the bidder profile can include a listing of bidders, an auction participation measure for each of the bidders, bidding statistics for each of the bidders, and an asset type (e.g., bond ratings) for each of the bidders. In particular, the bidding statistics for each of the bidders can include information relating to a price talk submission percentage (PxTalkSubm%), an average price talk deviation (AvgPxTalkDeviation), a number of bids (Bid#), an average number of improvement bids within each auction (AvgImpv#), total trades, and win percentage (Win %). Based upon the bidder profile information, the auction platform 200 can determine whom among the potential bidders exhibit behaviors most likely to lead to a quick and efficient auction with the best possible outcome for the seller.

### 1.4 Auction Invitation

Based upon the bidder profile generated by the auction platform 200, the seller can, through his or her seller terminal 224, define a set of rules or parameters that constitute an auction profile. Generally, an auction profile can include: an identity of an asset or assets to be auctioned, a number and identity of bidders that will compose a first set of bidders, an auction duration, whether the bids will be open or in confidence, a number of bids that may be submitted by each of the first set of bidders, a number of improvement bids that may be submitted by each of the first set of bidders, a reserve (if applicable), and a number of bidders that will be selected to advance to a subsequent round of bidding.

Therefore, a seller terminal 224 can execute Blocks of the first method S1oo by accepting seller input. For example, a seller can specify that the auction will include a set of securities including debt securities, fine art, collectible cars, or an NFT. The seller can further specify that only certain bidders will be invited to the auction (e.g., brokerages, auction houses, etc.) based upon the bidder profile generated by the auction platform 200. The seller can further specify that the auction will last for one hour and each invited bidder can submit a total of two confidential bids, one initial and one improvement bid. The seller can optionally set a reserve price for the asset (if applicable). Furthermore, the seller can set a limit on how many of the invited bidders will be invited to a subsequent round. For example, if the initial set of bidders includes twenty bidders, the seller can specify that only the top three (or five, or ten) bidders will advance to a subsequent auction round. Accordingly, the seller terminal 224 can receive, configure, and store these preferences into an auction profile that is configured to optimize the duration and outcome of the auction, thereby preserving computing and network resources within the auction platform 200.

Generally, the auction platform 200 can execute Blocks of the first method S100 at the auction server 210 by: receiving, from a seller terminal 224, the auction profile for the auction item in Block S120; generating the auction program based upon the auction profile in Block S122; and transmitting auction invitations to a set of bidders at a set of bidder terminals 222 in Block S124. As noted above, the auction profile can include a set of preferences and parameters by which the online auction can be conducted. After receiving the auction profile from the seller terminal 224, the auction server 210 can automatically generate an auction program (e.g., a set of computer-based rules) through which the auction is conducted, including execution of additional Blocks of the first method S100 and variations thereof.

In response to the identification of the first set of bidders, the auction server 210 can execute Blocks of the first method S100 by automatically transmitting invitations to the designated bidders via the bidder terminals 224. For example, the auction profile can indicate that the first set of bidders within the set of bidders can be invited to the auction, such as through a secure link to a website or application portal through which the bidder terminals 224 interface with the auction server 210. Therefore, the auction server 210 can transmit to a set of bidder terminals 224 an electronic message containing a link that can be opened either by a browser application 150 or by a native auction application 154 running on the selected bidder terminals 224.

In one variation of the example implementation, the auction invitation can include a set of specific auction instructions, displayable on the selected bidder terminals 224, that instruct a bidder-user on the auction profile information, (e.g., identifying information for the asset being auctioned), instructions for progressing from the first phase to the second phase of the auction, acceptance of a single best bid, limited access to second phase, limited information sharing between bidders, etc. For example, the bidder terminals 224 can display the auction invitation, which can include a set of guidelines or rules on how the auction is to be conducted, including: what the seller is auctioning, when the auction begins, how long the first phase of the auction will last, how many bidders are permitted in the first phase of the auction, how many bidders are permitted in the second phase of the auction, rules for bid improvement, and rules for settlement, payment, and transmission of the auctioned asset.

The bidder terminal 222 can further execute Blocks of the first method S100 by transmitting a message confirming or declining attendance to the auction server 210. At the auction server 150, a listing of accepted bidders can be compiled and transmitted to the seller terminal 224, along with an option to either proceed with the auction or terminate the auction.

### 1.5 Auction

Generally, the auction server 210 can execute Blocks of the first method S100 by conducting a first phase of the auction profile by receiving a first set of electronic bids from the bidder terminals 224 in Block S130. In one variation of the example implementation, the first set of electronic bids is transmitted from the bidder terminals 224 to the auction server 210 in (near) real-time. In another variation of the example implementation, the first set of electronic bids is transmitted from the bidder terminals 224 to the auction server 210 at predetermined intervals (e.g., every fifteen minutes, en masse at an auction midpoint, or any other format or arrangement prescribed by the auction profile). In another variation of the example implementation, the auction server 210 can be configured to store each electronic bid for further analysis and quantification of the bidder profile for each bidder in the auction.

The auction server 210 can further execute Blocks of the first method S100 by evaluating the first set of electronic bids based on the auction instructions for progressing from the first phase to the second phase of the auction in Block S132. As noted above, the auction profile can include a set of qualifications by which a bidder can be invited into a second phase of the auction, for example by having a bid ranked in the top N bids of the first phase of the auction, where N can be any number input into the seller terminal 224 upon auction construction.

Generally, the auction server 210 can further execute Blocks of the first method S100 by conducting a second phase of the auction profile in Block S134. Therefore, the auction server 210 can, based upon the auction instructions, transmit second phase invitations to a subset of the set of bidders at a subset of the bidder terminals 224 in Block S136. For example, the auction server 210 can transmit second phase invitations to the set of bidder terminals 224 associated with the N-highest bids received during the first phase of the auction. Additionally, the auction server 210 can transmit second phase declinations to the remaining bidder terminals 224 associated with the non-qualifying bids received during the first phase of the auction. In another variation of the example implementation, the auction server 210 can be configured to permit non-qualifying bidder terminals 224 to access the second phase of the auction, although without bidding permissions, so that the bidders associated with the non-qualifying bidder terminals 224 can gain insight into how to improve bidding performance in a subsequent auction.

Generally, the auction server 210 can execute Blocks of the first method S100 by receiving a second set of electronic bids from the subset of the bidder terminals in Block S138. Upon conclusion of the second phase of the auction, per the auction profile, the auction server 210 can transmit a set of results from the second phase of the auction to the seller terminal 224, displayable on the seller terminal 224 in Block S140. Generally, the set of results can include an auction winner (if any) and additional information associated with each bidder that can be used to refine and improve the bidder profile for each bidder in a subsequent auction.

In another variation of the example implementation, the auction profile can be configured to include more than two phases of the auction such that each successive phase reduces the number of bidder terminals 224 having bid permissions at the auction server 210, thereby incentivizing each bidder to maximize the value of his or her bid submissions at each phase of the auction. In doing so, the system, method, and computer program product described above can increase the efficiency of the electronic auction process by limiting the number of computing devices with access or permission in successive phases. In doing so, overall energy consumption from the associated computing devices is minimized, and valuable bandwidth is not needlessly consumed by computing devices with users who are not actively attempting to win the auction (e.g., by submitting low bids or trying to game the auction format through extended bids and bid improvements). Moreover, in requiring energy and bandwidth efficiency, bidders are incentivized to be direct and efficient in their submitted bids, which in turn benefits the seller in discovering the actual market value of the illiquid asset being auctioned.

### 1.6 Auction Settlement

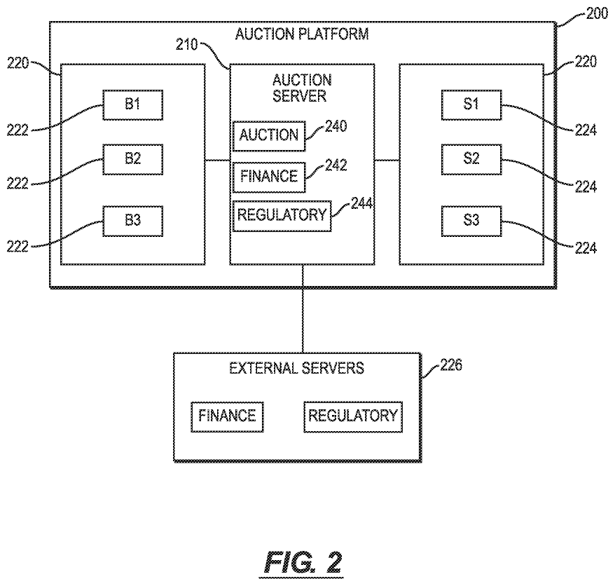

Generally, the auction server can execute Blocks of the first method S100 by automatically settling the auction transaction in Block S150. As noted above with reference to FIG. 2, the auction server 210 can include a financial module 242 that can connect to and communicate with a set of financial institutions (via the financial and regulatory servers 226) for the seller and the set of bidders. The auction server 210 can also include a regulatory module 244 that can connect to and communicate with a set of regulatory institutions (via the financial and regulatory servers 226) including, for example, securities exchange regulatory servers, taxation regulatory servers, and other government or international finance, banking, or reporting servers.

For example, each of the bidder terminals 224 and the seller terminal 224 can include an auction application 154 through which they are registered with the auction server 210 and through which the auction server 210 (through one or more modules) can execute Blocks of the first method S100. Therefore, in an example auction of an illiquid security or financial product, the auction server 210 can be connected to a financial account and an asset account (e.g., brokerage account) associated with each of the bidder terminals 224 (and bidders) and a financial account and an asset account (e.g., brokerage account) associated with the seller terminal (and seller).

Additionally, the auction server 210 can be connected to additional remote servers, either as a matter of convenience or per regulatory requirements including, for example, regulatory, tax, and reporting databases relating to the sale and purchase of illiquid assets. Therefore, in an example auction of an illiquid asset such as a collectible car, the auction server 210 can be connected to a set of state or federal reporting databases for reporting the sale and purchase of the car, such as the relevant motor vehicle registration authorities, taxation authorities, and insurance entities.

Accordingly, the auction server 210 can further execute Blocks of the first method S100 by communicating with a set of external servers upon acceptance of the bid by the seller at the seller terminal 224 in Block S152. For example, upon acceptance of a winning bid by the seller at the seller terminal 224, the auction server 210 can transmit computer readable instructions to the bidder financial account to direct payment to the seller financial account in Block S154. Moreover, the auction server 210 can transmit computer readable instructions to the seller asset account to direct the asset to the bidder asset account in Block S156. For example, the auction server 210 can transmit identifying information of the underlying asset (e.g., CUSIP number, Vehicle Identification Number, etc.) along with pre-executed or executable title documents to perfect the transfer of title between the seller and the buyer. Additionally, the auction server 210 can transmit a computer readable report relating to the purchase and sale of the asset to third party regulators (e.g., securities or taxation regulators) in Block S156.

For example, in the auction of an illiquid security or financial product, the auction server 210 can be connected to respective financial accounts and asset accounts (e.g., brokerage accounts) associated with the buyer terminal 224 and the seller terminal 224. Upon auction conclusion, the auction server 210 can transmit instructions to the buyer financial account to transfer funds in an amount of the winning bid to the seller financial account, (e.g., through SWIFT, ACH, or other currency exchange protocols). The auction server 210 can transmit instructions to the seller brokerage account and the buyer brokerage account to transfer title to the identified security (e.g., by CUSIP number and quantity) from the seller to the buyer. In one variation of the example implementation, the auction server 210 can be configured to receive acknowledgement messages regarding the transfers from the respective financial and asset accounts prior to closing the auction.

Furthermore, in an auction of an illiquid security or financial product, the auction server 210 can be connected to external servers associated with the cognizant regulatory or taxation authorities to report the sale, purchase, quantity, purchase price, identifying information, and any additionally required or desired information. In one variation of the example implementation, the auction server 210 can be configured to transmit reporting information to regulatory or taxation bodies directly following closing the auction. Alternatively, the auction server 210 can be configured to transmit reporting information to the external servers associated with regulatory or taxation bodies at predetermined later times, such as quarterly, annually, or in accordance with pertinent reporting deadlines (e.g., tax filing deadlines).

### 2. Second Method

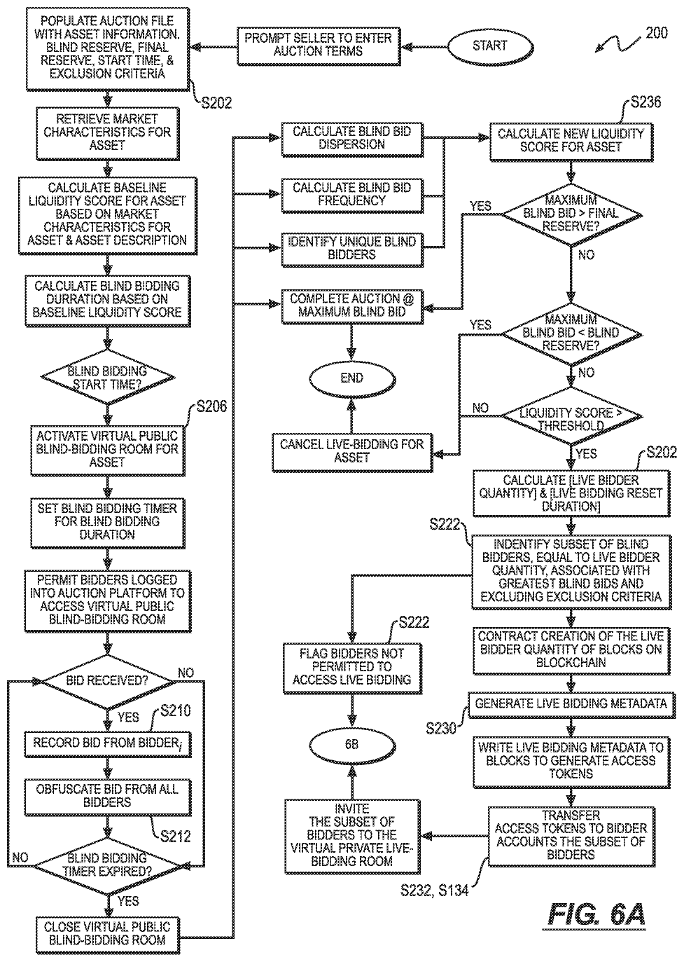

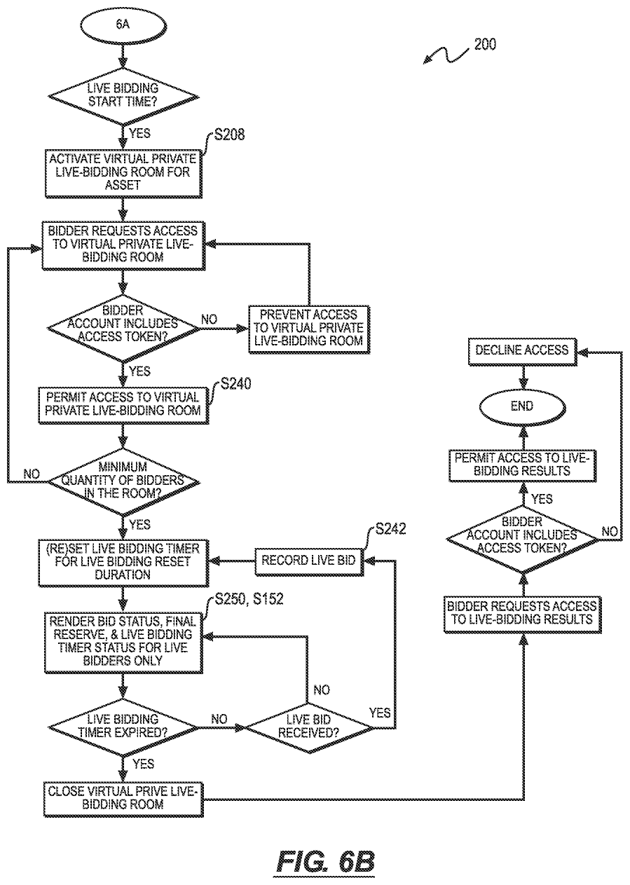

As shown in FIGS. 6A and 6B, a method S200 for hosting a multi-stage, token-gated electronic auction includes accessing a blind-bidding duration and a live-bidder quantity in Block S202. The method S200 also includes, for each bidder in a first group of bidders during a blind-bidding period of the blind-bidding duration: receiving a bid, in a first set of bids, from the bidder via an electronic bidding portal hosted by an electronic biding platform in Block S210; and obfuscating bid values of bids, in the first set of bids and received from each other bidder in the first group of bidders, at the electronic bidding portal in Block S212.

The method S200 further includes, in response to conclusion of the blind-bidding period: selecting a first subset of bidders, in the first group of bidders, equal to the live-bidder quantity and associated with bids of greatest bid value in the first set of bids in Block S220; isolating a second subset of bidders in the first group of bidders and excluding the first subset of bidders in Block S222; generating a set of digital access tokens for live-bidding in Block S230; assigning the set of digital access tokens to the first subset of bidders in Block S232; and transmitting a set of live-bidding notifications to the first subset of bidders via the electronic bidding portal in Block S234.

The method S200 also includes, during a live-bidding period succeeding the blind-bidding period: enabling bidding access by the first subset of bidders based on the set of digital access tokens in Block S240; receiving a second set of bids from the first subset of bidders in Block S242; for each bidder in the first subset of bidders, publishing bid values of bids, in the second set of bids and received from each other bidder in the first subset of bidders, at the electronic bidding portal in Block S250; and, for each bidder in the second subset of bidders, obfuscating bid values of bids in the second set of bids in Block S252.

One variation of the method S200 includes: accessing a first reserve value and a second reserve value in Block S202; and activating a virtual public blind-bidding room in Block S206. This variation of the method S200 also includes, for each bidder in a first group of bidders during a blind-bidding period of a blind-bidding duration: receiving a bid, in a first set of bids, from the bidder via the virtual public blind-bidding room in Block S210; and obfuscating the first reserve value and bid values of bids, in the first set of bids and received from each other bidder in the first group of bidders, within the virtual public blind-bidding room in Block S212.

This variation of the method S200 further includes, in response to conclusion of the blind-bidding period: selecting a first subset of bidders, in the first group of bidders, associated with bids of bid value greater than the first reserve value, in Block S220; isolating a second subset of bidders in the first group of bidders and excluding the first subset of bidders in Block S222; generating a set of digital access tokens for live-bidding in Block S230; assigning the set of digital access tokens to the first subset of bidders in Block S232; and initializing a virtual private live-bidding room in Block S208. This variation of the method S200 also includes, during a live-bidding period succeeding the blind-bidding period: enabling bidding access by the first subset of bidders within the virtual private live-bidding room based on association of the first subset of bidders to the set of digital access tokens in Block S240; receiving a second set of bids from the first subset of bidders via the virtual private live-bidding room in Block S242; for each bidder in the first subset of bidders, publishing the second reserve value and bid values of bids, in the second set of bids and received from each other bidder in the first subset of bidders, within the virtual private live-bidding room in Block S250; and, for each bidder in the second subset of bidders, excluding access to the virtual private live-bidding room and obfuscating the second reserve value and bid values of bids in the second set of bids in Block S252.

### 2.1 Applications

Generally, a computer system (e.g., the auction platform described above) can execute Blocks of the method S200: to host blind-bidding on an asset (e.g., a physical or digital asset or artwork, a security, etc.) by many bidders within a virtual public blind-bidding room over a relatively long time period (e.g., days, weeks); and to obfuscate bidding information from these many bidders within the virtual public blind-bidding room, such as number of bidders, bid values, and the relative bid positions of bidders, in order to incentivise bidders to place bids at their own true perceived value of the asset, rather than based on bids placed by others. The computer system further executes Blocks of the method S200: to isolate a small quantity of bidders who most value the asset based on their blind bids entered in the virtual public blind-bidding room; to generate a limited quantity of access tokens (or other login credentials) that control access to a virtual private live-bidding room for live bidding on the asset; and to assign these access tokens to these few bidders who most value the asset according to their bids placed in the virtual public blind-bidding room.

The computer system then executes Blocks of the method S200: to host live-bidding on the asset by the few bidders who most value the asset in a virtual private live-bidding room; to serve bidding information to these few bidders who hold access tokens, such as a quantity of bidders present in the room, bid values entered by these few bidders, and the relative bid positions of these live bids; and to obfuscate such bidding information from all other bidders who participated in blind-bidding in the virtual public blind-bidding room but who submitted lesser blind bids.

More specifically, the computer system can execute Blocks of the method S200 to automatically: open and close virtual public and private rooms for blind- and live-bidding, respectively, of a digital or physical asset or security; generate digital access tokens (or other credentials) to control access to the virtual private live-bidding room for a subset of bidders from the virtual public blind-bidding room; to control access to the virtual private live-bidding room based on these digital access tokens; and to reveal bid values, bid quantities, and/or bidder identities, etc. to select bidders with digital tokens within the virtual private live-bidding room. Accordingly, the computer system can execute a bidding protocol that incentivizes bidders to place the greatest blind bids and/or blind bids nearest the market clearing value (e.g., the true market value) of the asset: by restricting final bidding on the asset to only those bidders with the highest blind bids; and by enabling only bidders with the greatest blind bids to access final sale information on the asset, such as quantity of bids, final bid value, bidder identities, and the current market clearing value of the asset.

Furthermore, because the computer system incentivizes bidders to place blind bids nearest the market clearing value of the asset, the computer system can also characterize liquidity of the asset based on characteristics of bids entered by a larger group of bidders within the virtual public blind-bidding room. For example, the computer system can calculate a liquidity of the asset: proportional to the total quantity of unique blind bidders and an average bid value of blind bids entered; and inversely proportional to a variance of these blind bids and a difference between minimum and maximum blind bids.

The computer system can also automatically set live-bidding parameters for the virtual public blind-bidding room in real-time based on the liquidity of the asset, such as: a maximum time between consecutive bids (i.e., a “live-bidding reset duration”); a quantity of bidders from the virtual public blind-bidding room admitted into the virtual private live-bidding room; a delay time between conclusion of blind-bidding and start of live-bidding; and/or whether to cancel the auction prior to live-bidding, complete the auction prior to live-bidding, or activate live-bidding following blind-bidding. The computer system can then selectively and automatically execute live-bidding within the virtual private live-bidding room based on these auction parameters derived from characteristics of blind bids placed by many bidders in the virtual public blind-bidding room.

### 2.1.2 Example

In one example, the computer system can automatically execute the method S200 during sale of an illiquid or a low-liquidity asset (e.g., real estate, fine art, debt or equity tranches in collateralized loan obligations, leveraged loans, asset- and mortgage-backed securities) to: collect bids from many bidders in a virtual public blind-bidding room over a long blind-bidding period (e.g., days, weeks); obfuscate bid quantity, bid frequency, bid value, and/or bidder identity data from individual bidders, thereby incentivizing bidders to place bids according to their individual perceptions of the market value of the asset; and characterize liquidity of the asset at the current time based on blind bids entered by these many bidders. In this example, computer system further isolates a small(er) quantity of bidders associated with greatest blind bids for the asset, who therefore perceive greatest value of the asset, and who may place the highest bids for the asset when bidding against similar bidders in a fast-paced virtual private live-bidding room in which bid quantity, bid frequency, bid value, and/or bidder identity data is exposed to these bidders.

In this example, the computer system then: generates digital credentials for these few bidders to enter the virtual private live-bidding room; collects bids from these bidders within the virtual private live-bidding room; publishes times, values, and/or quantities of bids placed for real-time access by these few bidders with digital credentials; resets a live-bidding timer (e.g., to a duration less than 1% of the duration of the blind-bidding period) upon receipt of each subsequent bid within the virtual private live-bidding room; and closes live-bidding in the virtual private live-bidding room in response to expiration of the live-bidding timer prior to receipt of a next bid.

### 2.2 Bidding Parameters

Generally, in Block S202, the computer system can access and/or calculate blind- and/or live-bidding parameters that control the virtual blind- and private live-bidding rooms.

In one implementation, the computer system hosts a first seller portal accessible via a seller's computing device. In this implementation, the computer system interfaces with the seller via the virtual seller portal to receive auction information and parameters manually entered by the seller, such as: asset information (e.g., description, images); blind-bidding duration (e.g., days, weeks, months); a live-bidding reset duration; a blind-bidding reserve; a live-bidding (or “final”) reserve; a quantity of live bidders permitted in the virtual private live-bidding room; a quorum or proportion of the quantity of live bidders required to enter the virtual private live-bidding room before start of live-bidding; and/or characteristics of bidders excluded from the virtual private live-bidding room. For example, the computer system can: serve a form containing prompts or input fields for the foregoing auction parameters to the seller via the auction portal; and then populate an electronic auction file with parameters manually entered into the form by the seller. The computer system can retrieve these auction parameters from the electronic auction file during the subsequent blind- and live-bidding periods.

In another implementation, the computer system prompts the seller to manually set the blind-bidding duration only. The computer system then implements methods and techniques described below to: host the virtual public blind-bidding room during a blind-bidding period; characterizes liquidity of the asset based on results of the blind-bidding period of this blind-bidding duration; and sets a live-bidding reset duration, sets a quantity of live bidders, and/or or confirms live-bidding on the assets, etc. based on the liquidity of the asset.

In a similar implementation, prior to initiating blind-bidding for the asset within the virtual public blind-bidding room, the computer system: implements methods and techniques described in U.S. patent application Ser. No. 16/820,349 to calculate a liquidity of the asset; and then calculates or sets blind- and live-bidding parameters for the virtual private live-bidding room based on the liquidity of the asset, as described below. For example, the computer system can automatically set the blind-bidding duration inversely proportional to the liquidity of the asset. Following completion of the blind-bidding period, the computer system can calculate live-bidding parameters based on characteristics of blind bids recorded during the blind-bidding period.

In the foregoing implementations, the computer system can additionally or alternatively prompt the seller to manually set: a blind-bidding reserve; a live-bidding (or “final”) reserve, such as greater than the blind-bidding reserve; a target conclusion date of the auction; and/or characteristics of bidders to permit entry into the virtual public blind-bidding room but to exclude from the virtual private live-bidding room (e.g., banks, bidders with insufficient liquidity) regardless of their bid values.

### 2.3 Bidder Accounts

The computer system can similarly host a set of bidder accounts for a population of bidders on the auction platform. For example, for each bidder, the computer system can generate and store a bidder account including: a bidder username; a password; a bid limit or fund availability; payment information; and bidder characteristics, such as bidder type (e.g., bank or buy-side bidder), bid and payment history, and bidder location.

The computer system can thus enable any bidder with a bidder account on the auction platform to login, access the virtual private live-bidding room, and place a blind bid for the asset in the virtual private live-bidding room. Furthermore, the computer system can set and implement a blind bid cap for a bidder based on a bid limit or fund availability stored in the bidder's account.

### 2.4 Auction Start and Virtual Public Blind-bidding Room

Block S206 of the method S200 recites activating the virtual public blind-bidding room. Blocks S210 and S212 of the method S200 recite, for each bidder in a first group of bidders during a blind-bidding period of a blind-bidding duration: receiving a bid, in a first set of bids, from the bidder via the virtual public blind-bidding room; and obfuscating bid values of bids—received from each other bidder in the first group of bidders—within the virtual public blind-bidding room. Generally, in Blocks S206, S210, and S212, the computer system can initialize the virtual public blind-bidding room, collect blind bids from any bidder with a bidder account in the auction platform, and provide no or very limited color on bid activity to bidders in the virtual public blind-bidding room.

In one implementation, the computer system initializes the virtual public blind-bidding room through a login-gated webpage or native application hosted on the auction platform in Block S206. The computer system further enables any bidder with a bidder account on the auction platform to access the virtual public blind-bidding room, such as by logging in to their bidder accounts on the auction platform and then selecting the asset or virtual public blind-bidding room posted on the webpage or native application.

Upon initiating the virtual public blind-bidding room, the computer system can also: initiate a blind-bidding timer for the blind-bidding duration; and present the blind-bidding timer to bidders, thereby enabling these bidders to monitor blind-bidding time remaining.

### 2.4.1 Blind Bids and Bid Color

For a first bidder in this first group of blind bidders, the computer system can: receive and verify a login by the first bidder into the first bidder's account on the auction platform; permit the first bidder to enter the virtual public blind-bidding room; receive and record a first bid from the first bidder within the virtual public blind-bidding room during the blind-bidding period; obfuscate bid values of all other bids entered by all other bidders and the identities of all other bidders in the public blind-bidding room during the blind-bidding period; obfuscate the relative position of the first bidder's blind bid relative to other bids received at the virtual public blind-bidding room; and present the status of the blind-bidding timer to the first bidder. For example, the computer system can: store the first bidder's blind bid in a private, encrypted ledger. In another example, the computer system: generates bid metadata identifying the first bidder and the first bidder's bid quantity; encrypts these bid metadata; initiates generation of a block containing these bid metadata on a blockchain; and transfers the block to a digital wallet associated with the first bidder.

The computer system can implement similar methods and techniques to record blind bids and obfuscate other bid information for each other bidder participating in the virtual public blind-bidding room.

### 2.4.2 Blind-bidding Color

In one variation, the computer system presents limited bid color—such as whether the first bidder's bid is sufficient to access the virtual private live-bidding room—to the first bidder.

In one implementation, the computer system: accesses a live-bidder quantity (i.e., a quantity of blind bidders permitted to enter the virtual private live-bidding room, such as “ten bidders”); and accesses a threshold color quantity (i.e., a quantity of blind bidders permitted to access bid information of other bidders, such as “five bidders”), such as less than the live-bidder quantity. Upon receipt of a bid from a particular bidder in the virtual public blind-bidding room, the computer system can: communicate to the particular bidder that this bid is within the top threshold color quantity of bids and thus that the particular bidder is currently on a list of bidders to access the virtual public blind-bidding room if the bid is within the threshold color quantity of highest blind bids currently recorded; or otherwise provide no further feedback to the particular bidder. Therefore, the computer system can incentivize the particular bidder to submit a second, greater bid by providing no color on her low bid. Furthermore, in response to receipt of another bid that displaces the particular bidder from the threshold color quantity of highest blind bids received for the asset during the blind-bidding period, the computer system can transmit a notification to the particular bidder or otherwise indicate to the particular bidder that her bid is no longer in the threshold color quantity of highest blind bids that necessarily confers access to the virtual private live-bidding room, thereby incentivizing the particular bidder to enter another greater blind bid.

Later, the computer system can generate access tokens for the live-bidder quantity of bidders who entered the greatest blind bids in the virtual public blind-bidding room and permit these select bidders to enter the virtual private live-bidding room.

Furthermore, in this implementation, the computer system can: set the threshold color quantity less than the live-bidder quantity; provide bid color to fewer top bidders during the blind-bidding period than the quantity of bidders who subsequently gain access to the virtual private live-bidding room; and thus incentivize bidders who entered bids within the top live-bidder quantity of blind bids but outside of the threshold color quantity of blind bids to enter even greater blind bids in the virtual public blind-bidding room.

For example, the computer system can access or calculate: a live-bidder quantity and a threshold color quantity that is less than the live-bidder quantity. During the blind-bidding period, in response to receiving a first bid from a first bidder at a first electronic bidding portal at a first time and in response to a first value of the first bid falling within the threshold color quantity of highest-value bids received from the group of bidders by the first time, the computer system can: generate a first electronic notification of presence of the first bid in the threshold color quantity of bids received by the first time; transmit the first electronic notification to the first electronic bidding portal; and obfuscate a first quantity of bids received by the first time from the first bidder at the first electronic bidding portal. Similarly, in response to receiving a second bid from a second bidder at a second electronic bidding portal at a second time and in response to a second value of the second bid falling outside of the threshold color quantity of highest-value bids in the first set of bids received from the group of bidders by the second time, the computer system can: obfuscate a second quantity of bids and bid values of bids, in the first set of bids, received by the second time from the second bidder at the second electronic bidding portal. Upon completion of the blind-bidding period, the computer system can generate the live-bidder quantity of digital access tokens, which limit bidding access during the subsequent live-bidding period to the live-bidder quantity of bidders from the population of bidders. In particular if the first and second bids fall within the top live-bidder quantity of blind bids, the computer system can generate a first access token for the first bidder and a second access token for the second bidder and permit both the first and second bidders to access the virtual private live-bidding room, even if the second bid fell outside of the threshold color quantity and even if the computer system obfuscated blind bid information from the second bidder during the blind-bidding period.

### 2.5 Live-Bidding Preparation

As shown in FIG. 6A, upon conclusion of the blind-bidding time, the computer system can: close the virtual public blind-bidding room; access and/or define live-bidding parameters for the upcoming virtual private live-bidding room; and generate and distribute access tokens for the virtual private live-bidding room to select bidders who entered the greatest blind bids. More specifically, in response to conclusion of the blind-bidding time, the computer system can: select a first subset of blind bidders equal to the live-bidder quantity and associated with bids of greatest bid value in the first set of bids in Block S220; isolate a second subset of blind bidders excluding the first subset of bidders in Block S222; generate a set of digital access tokens (e.g., non-fungible tokens, temporary login credentials) for live-bidding on the asset in Block S230; assign the set of digital access tokens to the first subset of bidders in Block S232; and transmit a set of live-bidding notifications to the first subset of bidders via the electronic bidding portal or otherwise inform the first subset of bidders of their access tokens for the virtual private live-bidding room in Block S234.

For example, the computer system can execute these Blocks of the method S200 to generate live-bidding parameters, generate access tokens for the virtual private live-bidding room, and distribute access tokens and electronic live-bidding access notifications to select bidders in real-time and immediately upon conclusion of the blind-bidding period.

### 2.5.1 Liquidity

In one variation shown in FIG. 6A, the computer system characterizes the liquidity of the asset based on blind bids received during the blind-bidding period in Block S236. More specifically, dispersion of blind bids, bid variance, difference between minimum and maximum blind bids, quantity of blind bids, quantity of unique blind bidders, and frequency of inbound blind bids, etc. entered during the blind-bidding period may predict the demand for the asset, market confidence in the asset, the true market clearing price of the asset, and therefore the liquidity of the asset. By executing the blind-bidding period first, the computer system can: collect current such blind bid data prior to the live-bidding period; derive or predict the current true liquidity of the asset based on these blind bid data; and further identify a subset of bidders who perceive greatest value of the asset and who are most likely to enter the greatest bid values for the asset during a live-bidding period. The computer system can then set or adjust live-bidding parameters for the asset automatically (and in real-time) based on this derived liquidity of the asset.

In one implementation, the computer system predicts lower bidder confidence in or knowledge of the true value of the asset and therefore lesser liquidity of the asset in response to: greater bid dispersion; greater bid variance; a greater difference between the minimum and maximum blind bids for the asset; a higher ratio of total quantity of bids to quantity of unique bidders; etc. Similarly, the computer system can predict lesser demand and therefore lesser liquidity for the asset in response to: participation of fewer unique blind bidders; a low ratio of the maximum or average blind bid to the blind reserve set for the blind-bidding period; etc. Therefore, the computer system can calculate such blind bid characteristics and estimate the liquidity of the asset inversely proportional to: the dispersion of the set of blind bids; the bid variance; the difference between the minimum and maximum blind bids; a ratio of total quantity of bids to quantity of unique bidders; etc. Additionally or alternatively, the computer system can calculate the liquidity of the asset proportional to: a quantity of unique blind bidders participating in the virtual public blind-bidding room; and a ratio of the maximum or average blind bid to the blind reserve set for the blind-bidding period; etc.

Additionally or alternatively, the computer system can implement methods and techniques described in U.S. patent application Ser. No. 16/820,349 to calculate a liquidity of the asset, such as based on: market data collected outside of the virtual public blind-bidding room; and/or blind bid data collected within the virtual public blind-bidding room.

Therefore, the computer system can execute the blind-bidding period to both: isolate a subset of bidders who perceive a greatest value of the asset; and capture blind bid data representative of the current liquidity of the asset. The computer system can then automatically derive the liquidity (e.g., a liquidity score) of the asset based on these blind bid data.

### 2.5.2 Live Bidder Quantity

In one implementation shown in FIG. 6A, the computer system then calculates a quantity of bidders—from the virtual public blind-bidding room—to permit into the virtual private live-bidding room based on characteristics of blind bids received during the blind-bidding period.

In one example, if the asset is more liquid, more bidders may place more competitive live bids and thus increase the sale price of the asset. Conversely, if the asset is less liquid, more bidders may place low or uncompetitive live bids and thus slow live auction momentum. Therefore, in this example, the computer system can calculate the live-bidder quantity proportional to the liquidity of the asset.

In another example, the computer system calculates the live-bidder quantity proportional to the quantity of unique blind bidders, such as: 5% of the quantity of unique bidders, but no fewer than a minimum live bidder quantity (e.g., “five”) in order to ensure a competitive live bidding environment.

Alternatively, the computer system can retrieve a preset live-bidder quantity, such as set manually by the seller.

### 2.5.3 Live-Bidding Reset Duration

The computer system can similarly calculate a live-bidding reset duration for the virtual private live-bidding room based on characteristics of blind bids received during the blind-bidding period, as shown in FIG. 6B.

In one example, if the asset is more liquid, bidders may be more likely to place higher bids when under short time constraints. Conversely, if the asset is less liquid, bidders may be more likely to find additional capital or rational for bidding if afforded more time between live bids. Therefore, in this example, the computer system can calculate the live-bidding reset duration inversely proportional to the liquidity of the asset.

Alternatively, the computer system can calculate the live-bidding reset duration as a function of (e.g., less than 1% of) the blind-bidding duration. For example, the computer system can set the live-bidding reset duration at 0.01% of the blind-bidding duration. Thus, for a one-week blind-bidding duration totaling approximately 10,000 minutes, the computer system can set a live-bidding reset duration of one minute. Therefore, in this example, the computer system can: permit any bidders to place any quantity of blind bids within the virtual public blind-bidding room at any time over a period of one week; and then permit a subset of these bidders—assigned access tokens based on their blind-bidding activity—to place live bids within the virtual private live-bidding room with no more than one minute between consecutive bids in order to incentivize rapid bidding and to build auction momentum.

### 2.5.4 Live Bidder Selection and Tokens

The computer system also: selects a quantity of bidders—equal to the live-bidder quantity—who placed highest blind bids during the blind-bidding period; generates access tokens for the virtual private live-bidding room; and assigns these access tokens to these select bidders. More specifically, the computer system can generate temporary or persistent digital access credentials—such as in the form of non-fungible tokens stored on a blockchain of temporary electronic login credentials—for accessing the virtual private live-bidding room. The computer system then distributes these access tokens to these bidders, who may then enter the virtual private live-bidding room via their access tokens, place live bids, and view live bid data from other select bidders.

In one implementation shown in FIG. 6A, each bidder account in the auction platform is connected to a digital wallet. During or in preparation for the auction for the asset, the computer system: generates live-bidding room access metadata; contracts a set of machines to generate a set of blocks—on a blockchain—equal to the live-bidder quantity; and links these live-bidding room access metadata and cryptographic hashes to these blocks, thereby forming a quantity of non-fungible tokens equal to the live-bidder quantity and linked to live-bidding access metadata. Alternatively, the computer system can contract the set of machines to write these live-bidding room access metadata directly to these blocks on the blockchain to form a quantity of non-fungible tokens equal to the live-bidder quantity and that contain live-bidding access metadata.

In this implementation, upon completion of the blind-bidding period, the computer system: retrieves or calculates the live-bidder quantity; selects a subset of bidders—equal to the live-bidder quantity—who placed blind bids of the greatest values during the blind-bidding period; and initiates a transfer on the blockchain to transfer one non-fungible token to the digital wallets associated with the bidder accounts of this subset of bidders.

Later, the computer system can: initialize a token-gated virtual private live-bidding room; and configure the virtual private live-bidding room to query digital wallets for non-fungible tokens containing bidding room access metadata (or linked to bidding room access metadata via a cryptographic hash). This, the virtual private live-bidding room can automatically enable a bidder—associated with a bidder account linked to a digital wallet that contains a non-fungible token described above—to access the virtual private live-bidding room, place live bids, and view live bid information. However, the virtual private live-bidding room can also automatically prevent a bidder—associated with a bidder account linked to a digital wallet that does not contain a non-fungible token described above—from accessing the virtual private live-bidding room, placing live bids, or viewing live bid information.

Therefore, in this implementation, the computer system can automatically generate and distribute non-fungible tokens—containing or linked to live-bidding room access metadata—to digital wallets associated with select bidders from the blind-bidding period and automatically control access to the virtual private live-bidding room based on these non-fungible tokens, thereby enabling these select bidders to immediately access the virtual private live-bidding room without an additional login, a new username, a new password, or other new user-managed login credentials.

In a similar implementation, the computer system loads a secondary access credential—linked to the virtual private live-bidding room—into the bidder account of each bidder in the subset of bidders selected for the virtual private live-bidding room. In this implementation, the computer system can similarly configure the virtual private live-bidding room to verify this secondary access credential in the bidder account of each bidder requesting access to the virtual private live-bidding room and selectively enable bidders to enter the virtual private live-bidding room based on presence of this secondary access credential in these bidder accounts.

In another implementation, the computer system generates a temporary or secondary username, password, and/or other login credential for each bidder in the subset of bidders selected for the virtual private live-bidding room. The computer system then: generates a notification for each bidder in this subset of bidders; and populates each notification with a prompt to enter the virtual private live-bidding room and with the temporary or secondary username, password, and/or other login credential. The computer system then transmits these notifications to their corresponding bidders, such as in the form of: an email; an in-application notification; a text message; or a pop-up notification in the bidder portals of these bidders upon conclusion of the blind-bidding period. The virtual private live-bidding room can then enable bidders who supply accurate temporary or secondary username, password, and/or other login credentials to access the virtual private live-bidding room, place live bids, and view living bidding information.

### 2.5.4.1 Persistent Color

In the foregoing implementations, the computer system can generate persistent digital access tokens that enable the selected bidders: to access the virtual private live-bidding room, place live bids on the asset, and view living bidding information in real-time during the live-bidding period; and to later access live bid data for the live-bidding period (and the related blind bidding period) upon conclusion of the live-bidding period, as shown in FIG. 6B.

For example, the computer system can generate a persistent security credential for a login session within an electronic bidding portal for each bidder in the first subset of bidders selected for the live-bidding period. The computer system can then enable entry into the virtual private live-bidding room via the electronic bidding portal during the live-bidding period in response to receipt of or detecting a digital access token for each bidder in this first subset of bidders. Furthermore, in response to conclusion of the live-bidding period, the computer system can disable submission of bids by the bidders in the first subset of bidders. However, following conclusion of the live-bidding period, the computer system can further enable access—via the electronic bidding platform—to bid values of bids placed during the live-bidding period in response to receipt of a digital access token from each bidder in the first subset of bidders.

Therefore, in this implementation, the computer system can generate and distribute access tokens or other credentials that enable this subset of bidders to access live bid information for the asset during and after the live-bidding period.

### 2.5.4.2 Temporary Color

Conversely, the computer system can generate and distribute access tokens or other credentials that enable this subset of bidders to access live bid information for the asset during the live-bidding period only.

In particular, in this implementation, the computer system can generate a set of digital access tokens configured to expire in response to conclusion of the live-bidding timer during the live-bidding period. Accordingly, the computer system can: access the live-bidding reset duration; activate the virtual public blind-bidding room during the live-bidding period; and enable entry into the virtual private live-bidding room via the electronic bidding portal during the live-bidding period in response to receipt of a digital access token from each bidder in the first subset of bidders.

Furthermore, during the live-bidding period, the computer system can: initiate a live-bidding timer for the live-bidding reset duration; and reset the live-bidding timer to the live-bidding reset duration in response to receiving each bid in the second set of bids during the live-bidding period. Then, in response to conclusion of the live-bidding timer, the computer system can: close the virtual private live-bidding room; initiate or prompt settlement between a winning bidder and the seller; remove the first subset of bidders from the virtual private live-bidding room; and retract access to live bid information for the asset from these bidders.

### 2.5.5 Bidder Removal by Characteristic

In one variation shown in FIG. 6A, the computer system further selectively removes bidders who participated in blind-bidding on the asset from consideration for live-bidding on the asset based on characteristics of these bidders, such as if the seller prefers not to sell to bidders of certain characteristics, such as: other dealers; bidders in certain geographic locations; dealers with less than a minimum liquidity; or bidders of a certain bidder class (e.g., banks rather than buy-side investors). More specifically, the computer system can: enable bidders with such excluding characteristics to enter blind bids on the asset during the blind-bidding period; but exclude such bidders from the first subset of bidders permitted to access the virtual private live-bidding room. Because the computer system obfuscates blind and live bid information from bidders outside of the virtual private live-bidding room, the computer system can also: obfuscate reasons for exclusion from bidders with excluding characteristics; improve bidder satisfaction and trust among these bidders; and incentivize better bids from these bidders during blind-bidding periods in future auctions for other assets.

In one implementation, the computer system accesses a specification for excluding a particular bidder characteristic from live-bidding on the asset, such as from the electronic auction file populated with auction data manually entered by the seller prior to the blind-bidding period. In this implementation, the computer system can receive blind bids from a first cohort of bidders characterized by a first bidder characteristic and a second cohort of bidders characterized by the particular bidder characteristic; and then select the first subset of bidders—for live-bidding on the asset—from the first cohort of bidders and excluding bidders from the second cohort of bidders based on the specification.

For example, the computer system can access the specification for: permitting the first cohort of bidders characterized by a buy-side bidder characteristic to access the virtual private live-bidding room; and excluding the second cohort of bidders characterized by a bank characteristic from the virtual private live-bidding room. Thus, in this example, the computer system can exclude banks from entering the virtual private live-bidding room, placing live bids on the asset, and accessing live (and blind) bid information for the asset.

(However, in this implementation, the computer system can still enable a bidder—in the second cohort of bidders—who placed a highest blind bid and exceeded the seller's reserve to win the auction for the asset if the computer system automatically closed the auction upon conclusion of the blind-bidding period, thereby incentivizing bidders in the second cohort to place high blind bids on assets over time and thus avoid exclusion from future virtual private live-bidding rooms.)

### 2.5.6 Auction Start Time

The computer system can also automatically set a start time for live-bidding on the asset, such as: immediately upon conclusion of the blind bidding period; or at a future scheduled time (e.g., one hour or one day later).

Furthermore, the computer system can set a threshold proportion of bidders required to enter the virtual private live-bidding room prior to start of live-bidding (e.g., a “quorum”), such as inversely proportional to the liquidity of the asset (e.g., 100% for a low-liquidity asset; 60% for a high-liquidity asset).

### 2.5.7 Reserve

In one implementation described above, the seller sets a reserve for the asset prior to start of the blind-bidding period.

In one variation, the computer system compiles blind bid data and transmits these blind bid data with a prompt to set a reserve to the seller between the blind- and live-bidding periods. The computer system can thus enable the seller to: review blind-bidding results; improve her understanding of liquidity of the asset; set or revise a final reserve of the asset; and/or confirm or cancel live-bidding on the asset in light of these blind-bidding results.

For example, in response to conclusion of the blind-bidding period, the computer system can: compile bid results of the blind-bidding period into an electronic notification; populate the electronic notification with a prompt to set a reserve value; and transmit the electronic notification to the seller. The computer system can then: receive the reserve value from the seller responsive to the electronic notification; publish the reserve value—for access by the first subset of bidders—within the electronic bidding portal during the live-bidding period; and obfuscate the reserve value from the second subset of bidders within the electronic bidding portal.

### 2.5.8 Bidder Notification and Login

The computer system can further notify the first subset of bidders of their selection as live bidders in the upcoming virtual private live-bidding room.

In one implementation, the computer system: selects the first subset of bidders in real-time immediately upon completion of the blind-bidding period; and pushes notifications with links and electronic bidding credentials to the first subset of bidders in real-time, such as through their bidding portals within the virtual public blind-bidding room, within the bidding accounts, via email, and/or via text message. The computer system can then enable these bidders to enter the virtual private live-bidding room via these notifications or otherwise with these electronic bidding credentials.

More specifically, the computer system can enable entry into the virtual private live-bidding room—via the electronic bidding portal during the live-bidding period—in response to receipt of a digital access token from each bidder in the first subset of bidders. For example, the computer system can: generate a digital access token containing security credentials for a login session within the electronic bidding portal for each bidder in the first subset of bidders as described above; transmit a live-bidding notification—containing a digital access token with security credentials—to each bidder in the first subset of bidders; and then enable submission of bids during the live-bidding period in response to selection of a security credential by each bidder in the first subset of bidders:

### 2.6 Virtual Private Live-bidding Room

Then, at the scheduled start time of live-bidding for the asset, the computer system can: activate the virtual private live-bidding room, such as a token-gated auction webpage; and set an initial bid value for the asset during the live-bidding period at a highest bid value of all bids placed during the blind-bidding period. The computer system can also set and activate a live-bidding timer for the live-bidding reset duration and enable bidding by bidders with access tokens for the virtual private live-bidding room, such as once a minimum proportion of these bidders enter the virtual private live-bidding room, as shown in FIG. 6B.

In particular, the computer system can: enable entry into a virtual private live-bidding room via the electronic bidding portal during the live-bidding period in response to receipt of a digital access token from each bidder in the first subset of bidders; enable submission of bids by these bidders during the live-bidding period only after a quantity of bidders present in the virtual private live-bidding room exceeds a threshold bidder quantity (e.g., a “quorum”); record live bids entered by these bidders; reset the live-bidding timer for the live-bidding reset duration in response to receipt of each subsequent bid prior to expiration of the live-bidding timer; and publish bid information for bidders within the virtual private live-bidding room, such as including current bid value, time remaining on the live-bidding timer, an identity or identifier of a bidder with the highest current live bid, quantity or identities of bidders present in the virtual private live-bidding room, and/or a final reserve set for the asset.

Once the live-bidding timer expires, the computer system can: close the virtual private live-bidding room; remove bidders from the virtual private live-bidding room; record a final bid value placed in the virtual private live-bidding room; cancel sale of the asset if this final bid value is less than a final reserve set for the asset; or initiate sale of the asset at this final bid value if this final bid value exceeds the final reserve or if no final reserve was set for the asset.

### 2.7 Canceled Live-Bidding+Completed Auction

In one implementation shown in FIG. 6A, the computer system cancels the virtual private live-bidding room and completes the auction if blind bids placed in the virtual public blind-bidding room meet or exceed the final reserve set for the asset, thereby shortening time from start of the blind-bidding period to completion of the auction for the asset and shortening time to a liquidity event for the seller and reducing complexity for bidders.

For example, the computer system can activate the virtual private live-bidding room and enable bidding on the asset by the first subset of bidders during a live-bidding period: if the liquidity of the asset—derived from blind bids placed during the blind-bidding period—exceeds a threshold liquidity or if the maximum blind bid value exceeds a blind reserve; and if the maximum blind bid value is less than the final reserve set for the asset.

Conversely, the computer system can cancel the virtual private live-bidding room and complete the auction for the asset at the maximum blind bid value at the conclusion of the blind-bidding period if the maximum blind bid value meets or exceeds the final reserve set for the asset.

### 2.8 Canceled Auction

In a similar variation shown in FIG. 6A, the computer system: activates the virtual private live-bidding room and hosts live-bidding on the asset by select buyers if a blind (or “first”) reserve is met by blind bids placed in the virtual public blind-bidding room; but cancels the auction and the virtual private live-bidding room if these blind bids fail to meet the blind reserve.

In a similar variation, the computer system: activates the virtual private live-bidding room and hosts live-bidding on the asset by select buyers if the liquidity of the asset—such as derived from blind bids placed in the virtual public blind-bidding room—exceeds a threshold liquidity; but cancels the auction and the virtual private live-bidding room if the liquidity of the asset falls below the threshold liquidity.

For example, the computer system can receive blind bids for the asset via the electronic bidding portal and obfuscate bid values placed by other blind bidders at the electronic bidding portal for each bidder in a group of bidders during the blind-bidding period. Then, in response to conclusion of the blind-bidding period, the computer system can: implement methods and techniques described above to characterize a liquidity of the asset inversely proportional to dispersion of this set of bids; and cancel bidding for the asset in response to the liquidity falling below a threshold liquidity.

### 2.9 Tranched Asset

In one variation, the computer system: accesses a blind-bidding duration in Block S202; and activates a virtual public blind-bidding room in Block S206. Then, during a blind-bidding period of the blind-bidding duration, the computer system receives a bid, in a first set of bids, from a bidder via the virtual public blind-bidding room in Block S210 and obfuscates bid values of bids, in the first set of bids and received from each other bidder in the first group of bidders, within the virtual public blind-bidding room in Block S212 for each bidder in a first group of bidders. Furthermore, in response to conclusion of the blind-bidding period, the computer system: selects a first subset of bidders, in the first group of bidders, associated with bids of greatest bid value in the first set of bids in Block S220; isolates a second subset of bidders in the first group of bidders and excluding the first subset of bidders in Block S220; generates a set of digital access tokens for live-bidding in Block S230; and assigns the set of digital access tokens to the first subset of bidders in Block S232. The computer system then initializes a virtual private live-bidding room in Block S208. Then, during a live-bidding period succeeding the blind-bidding period, the computer system: enables bidding access by the first subset of bidders within the virtual private live-bidding room based on association of the set of digital access tokens to the first subset of bidders in Block S240; and receives a second set of bids from the first subset of bidders via the virtual private live-bidding room in Block S242. Furthermore, the computer system: publishes bid values of bids, in the second set of bids and received from each other bidder in the first subset of bidders, within the virtual private live-bidding room for each bidder in the first subset of bidders in Block S250; and excludes access to the virtual private live-bidding room and obfuscates bid values of bids in the second set of bids for each bidder in the second subset of bidders in Block S252.

Generally, in this variation, the computer system executes Blocks of the method S200 to: host blind-bidding within a virtual blind-bidding room for tranched assets containing multiple like asset units saleable at different quantities, but at a common value; collect blind bids for quantities and values of the tranched asset from many bidders within the virtual public blind-bidding room; select a subset of bidders with blind bids specifying unit quantities in excess of all units of the tranched asset and specifying greatest bid values; host live-bidding within the virtual private live-bidding room; collect live bids for quantities and values of the tranched asset from the subset of bidders within the virtual private live-bidding room; and to isolate a final group of bidders with live bids specifying unit quantities equal to all units of the tranched asset and specifying greatest minimum bid value.

For example, the computer system can execute methods and techniques described in U.S. patent application Ser. No. 16/799,736 in conjunction with Blocks of the method S200 to: collect blind bids on securities in a tranche of an arbitrage collateralized loan obligation within a virtual public blind-bidding room; isolate a subset of blind bidders who placed blind bids of highest bid value (e.g., lowest interest rate) for a total security quantity in excess of a total size of the tranche; generate access tokens for this subset of bidders to access a virtual private live-bidding room; collect blind bids on securities in this tranche of the arbitrage collateralized loan obligation within the virtual public blind-bidding room; isolate a final set of bidders who placed live bids of highest bid value (e.g., lowest interest rate) for a total security quantity equal to the total size of the tranche; and to handle settlement and redistribution of all debt within the tranche to the final bidders at a lowest bid value (e.g., a highest interest rate) among the last live bids placed by bidders in this final set of bidders.

Therefore, in this variation, the computer system can: access a tranche quantity of an asset tranche in preparation for activating the virtual public blind-bidding room; and receive blind bids—including bid quantities (e.g., a quantity of asset units within the tranche) and bid value (e.g., an interest rate)—from each bidder in a first group of bidders. The computer system can also select the first subset of bidders—to subsequently access the virtual private live-bidding room—who placed blind bids of greatest bid value and totaling an aggregate quantity (e.g., sum of asset units) greater than the tranche quantity (e.g., the total quantity of assets in the tranche). The computer system can further receive live bids—including bid quantities and bid values—from the first subset of bidders in the virtual private live-bidding room. The computer system can then handle settlement and redistribution of all debt within the tranche to a final subset of these live bidders at a lowest bid value (e.g., a highest interest rate) among the final live bids placed by bidders within this final subset of live bidders.

As noted above, the systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above.

As a person skilled in the art will recognize from the previous detailed description and from the figures and claims, modifications and changes can be made to the embodiments of the invention without departing from the scope of this invention as defined in the following claims.

I claim:

1. A method comprising:
during a blind-bidding period of a blind-bidding duration:
for each bidder in a first group of bidders:
receiving a bid, in a first set of bids, from the bidder via an electronic bidding portal hosted by an electronic biding platform; and
obfuscating bid values of bids, in the first set of bids and received from each other bidder in the first group of bidders, at the electronic bidding portal;
in response to conclusion of the blind-bidding period:
selecting a first subset of bidders, in the first group of bidders:
equal to a live-bidder quantity; and
associated with bids of greatest bid value in the first set of bids;
isolating a second subset of bidders in the first group of bidders and excluding the first subset of bidders;
generating a set of digital access tokens for live-bidding;
assigning the set of digital access tokens to the first subset of bidders; and
transmitting a set of live-bidding notifications to the first subset of bidders via the electronic bidding portal; and
during a live-bidding period succeeding the blind-bidding period:
enabling bidding access by the first subset of bidders based on the set of digital access tokens;
receiving a second set of bids from the first subset of bidders;
for each bidder in the first subset of bidders, publishing bid values of bids, in the second set of bids and received from each other bidder in the first subset of bidders, at the electronic bidding portal; and
for each bidder in the second subset of bidders, obfuscating bid values of bids in the second set of bids.

2. The method of claim 1, further comprising:
calculating a live-bidding reset duration less than one percent of the blind-bidding duration;
setting an initial bid value during the live-bidding period at a highest bid value in the first set of bid values;
during the live-bidding period, initiating a live-bidding timer for the live-bidding reset duration; and
resetting the live-bidding timer to the live-bidding reset duration in response to receiving each bid in the second set of bids during the live-bidding period.

3. The method of claim 1, further comprising:
characterizing a liquidity of an asset inversely proportional to dispersion of the first set of bids;
calculating a live-bidding reset duration proportional to the liquidity of the asset;
setting an initial bid value for the asset during the live-bidding period at a highest bid value in the first set of bid values;
during the live-bidding period, initiating a live-bidding timer for the live-bidding reset duration; and
resetting the live-bidding timer to the live-bidding reset duration in response to receiving each bid in the second set of bids during the live-bidding period.

4. The method of claim 1:
further comprising accessing a live-bidder quantity and a threshold color quantity less than the live-bidder quantity;
further comprising, during the blind-bidding period:
in response to receiving a first bid, in the first set of bids, from a first bidder at a first electronic bidding portal at a first time:
in response to a first value of the first bid falling within the threshold color quantity of highest-value bids in the first set of bids received from the group of bidders by the first time:
generating a first electronic notification of presence of the first bid in the threshold color quantity of bids received by the first time;
transmitting the first electronic notification to the first electronic bidding portal; and
obfuscating a first quantity of bids, in the first set of bids, received by the first time from the first bidder at the first electronic bidding portal; and
in response to receiving a second bid, in the first set of bids, from a second bidder at a second electronic bidding portal at a second time:
in response to a second value of the second bid falling outside of the threshold color quantity of highest-value bids in the first set of bids received from the group of bidders by the second time:
obfuscating a second quantity of bids and bid values of bids, in the first set of bids, received by the second time from the second bidder at the second electronic bidding portal; and
wherein generating the set of digital access tokens for live-bidding comprises generating the live-bidder quantity of digital access tokens to limit bidding access during the live-bidding period to the live-bidder quantity of bidders from the group of bidders.

5. The method of claim 1:
further comprising accessing a specification for excluding a second bidder characteristic from live bidding;
wherein receiving a bid, in the first set of bids, during the blind-bidding period comprises receiving the first set of bids from the first group of bidders comprising:
a first cohort of bidders characterized by a first bidder characteristic; and
a second cohort of bidders characterized by the second bidder characteristic; and
wherein selecting the first subset of bidders comprises selecting the first subset of bidders from the first cohort of bidders and excluding bidders from the second cohort of bidders based on the specification.

6. The method of claim 5, wherein receiving a bid, in the first set of bids, during the blind-bidding period comprises receiving the first set of bids from the first group of bidders comprising:
the first cohort of bidders characterized by a buy-side bidder characteristic; and
the second cohort of bidders characterized by a bank characteristic.

7. The method of claim 1:
further comprising characterizing a first liquidity of a first asset inversely proportional to dispersion of the first set of bids;
wherein enabling bidding access by the first subset of bidders comprises enabling bidding access by the first subset of bidders for the first asset during the live-bidding period in response to the first liquidity exceeding a threshold liquidity; and
further comprising:
during a second blind-bidding period:
for each bidder in a second group of bidders:
receiving a second bid, in a second set of bids for a second asset, from the bidder via the electronic bidding portal hosted by the electronic biding platform; and
obfuscating bid values of bids, in the second set of bids and received from each other bidder in the second group of bidders, at the electronic bidding portal; and
in response to conclusion of the second blind-bidding period:
characterizing a second liquidity of the second asset inversely proportional to dispersion of the second set of bids; and
canceling bidding for the second asset in response to the second liquidity falling below the threshold liquidity.

8. The method of claim 1:
wherein generating the set of digital access tokens for live-bidding comprises:
for each bidder in the first subset of bidders:
generating a security credential for a login session within the electronic bidding portal by the bidder;
wherein transmitting the set of live-bidding notifications to the first subset of bidders via the electronic bidding portal comprises:
for each bidder in the first subset of bidders:
transmitting a live-bidding notification, in the set of live-bidding notifications and containing a security credential in the set of digital access tokens, to the bidder; and
wherein enabling bidding access by the first subset of bidders during the live-bidding period comprises:
for each bidder in the first subset of bidders:
enabling submission of bids during the live-bidding period in response to selection of a security credential, in the set of digital access tokens, by the bidder.

9. The method of claim 1, wherein enabling bidding access by the first subset of bidders during the live-bidding period comprises:
for each bidder in the first subset of bidders:
enabling entry into a virtual private live-bidding room via the electronic bidding portal during the live-bidding period in response to receipt of a digital access token, in the set of digital access tokens, from the bidder; and
in response to a quantity of bidders, in the first subset of bidders, present in the virtual private live-bidding room exceeding a threshold bidder quantity:
enabling submission of bids by the first subset of bidders during the live-bidding period.

10. The method of claim 1:
further comprising characterizing a liquidity of an asset inversely proportional to dispersion of the first set of bids;
further comprising calculating the live-bidder quantity proportional to the liquidity of the asset; and
wherein enabling bidding access by the first subset of bidders comprises enabling bidding access by the first subset of bidders for the first asset during the live-bidding period in response to the liquidity exceeding a threshold liquidity.

11. The method of claim 1:
further comprising, during the blind-bidding period, activating a virtual public blind-bidding room;
wherein receiving a bid, in the first set of bids, from a bidder in the first group of bidders during the blind-bidding period comprises, for each bidder in the first group of bidders:
receiving a bid, in the first set of bids, from the bidder logged into the virtual public blind-bidding room during the blind-bidding period;
wherein obfuscating bid values of bids from each other bidder in the first group of bidders from each bidder in the first group of bidders during the blind-bidding period comprises:
obfuscating bid values of bids and identities of other bidders, in the first group of bidders, in the public blind-bidding room from each bidder in the first group of bidders during the blind-bidding period;
further comprising, during the live-bidding period, activating a virtual private live-bidding room; and
wherein enabling bidding access by the first subset of bidders during the live-bidding period comprises, for each bidder in the first subset of bidders:
enabling entry into the virtual private live-bidding room via the electronic bidding portal during the live-bidding period in response to detecting a digital access token, in the set of digital access tokens, in a digital wallet associated with the bidder.

12. The method of claim 1:
wherein generating the set of digital access tokens for live-bidding comprises generating the set of digital access tokens configured to expire in response to conclusion of a live-bidding timer during the live-bidding period;
further comprising:
accessing a live-bidding reset duration; and
during the live-bidding period, activating a virtual public blind-bidding room;
wherein enabling bidding access by the first subset of bidders during the live-bidding period comprises, for each bidder in the first subset of bidders:
enabling entry into the virtual private live-bidding room via the electronic bidding portal during the live-bidding period in response to receipt of a digital access token, in the set of digital access tokens, from the bidder; and
further comprising, during the live-bidding period:
initiating a live-bidding timer for the live-bidding reset duration;
resetting the live-bidding timer to the live-bidding reset duration in response to receiving each bid in the second set of bids during the live-bidding period; and
in response to conclusion of the live-bidding timer, removing the first subset of bidders from the virtual private live-bidding room.

13. The method of claim 1:
wherein generating the set of digital access tokens for live-bidding comprises, for each bidder in the first subset of bidders:
generating a digital access token, in the set of digital access tokens, comprising a persistent security credential for a login session within the electronic bidding portal by the bidder;
wherein enabling bidding access by the first subset of bidders during the live-bidding period comprises, for each bidder in the first subset of bidders:
enabling entry into the virtual private live-bidding room via the electronic bidding portal during the live-bidding period in response to receipt of a digital access token, in the set of digital access tokens and comprising a persistent security credential, from the bidder; and
further comprising:
in response to conclusion of the live-bidding period, disabling submission of bids by the bidders in the first subset of bidders; and
for each bidder in the first subset of bidders:
enabling access to bid values of the second set of bids via the electronic bidding platform in response to receipt of a digital access token, in the set of digital access tokens, from the bidder following the live bidding period.

14. The method of claim 1:
further comprising accessing a first reserve of a first asset;
wherein enabling bidding access by the first subset of bidders comprises enabling bidding access by the first subset of bidders for the first asset during the live-bidding period in response to a highest bid, in the first set of bids, falling below the first reserve;
further comprising:
accessing a second reserve of a second asset;
during a second blind-bidding period of a second auction for the second asset:
for each bidder in a second group of bidders:
receiving a bid, in a third set of bids, from the bidder via an electronic bidding portal hosted by the electronic bidding platform; and
obfuscating bid values of bids, in the third set of bids and received from each other bidder in the second group of bidders, at the electronic bidding portal;
in response to a greatest bid, in the third set of bids, exceeding the second reserve, closing the second auction for the second asset without a second live-bidding period for the second asset.

15. The method of claim 1, further comprising:
in response to conclusion of the blind-bidding period:
compiling bid results of the blind-bidding period into an electronic notification;
populating the electronic notification with a prompt to set a reserve value; and
transmitting the electronic notification to a seller;
receiving the reserve value from the seller responsive to the electronic notification;
publishing the reserve value for access by the first subset of bidders within the electronic bidding portal during the live-bidding period; and
obfuscating the reserve value from the second subset of bidders within the electronic bidding portal.

16. A method comprising:
accessing a blind-bidding duration;
activating a virtual public blind-bidding room;
during a blind-bidding period of the blind-bidding duration:
for each bidder in a first group of bidders:
receiving a bid, in a first set of bids, from the bidder via the virtual public blind-bidding room; and
obfuscating bid values of bids, in the first set of bids and received from each other bidder in the first group of bidders, within the virtual public blind-bidding room;
in response to conclusion of the blind-bidding period:
selecting a first subset of bidders, in the first group of bidders, associated with bids of greatest bid value in the first set of bids;
isolating a second subset of bidders in the first group of bidders and excluding the first subset of bidders;
generating a set of digital access tokens for live-bidding; and
assigning the set of digital access tokens to the first subset of bidders;
initializing a virtual private live-bidding room; and
during a live-bidding period succeeding the blind-bidding period:
enabling bidding access by the first subset of bidders within the virtual private live-bidding room based association of the set of digital access tokens to the first subset of bidders;
receiving a second set of bids from the first subset of bidders via the virtual private live-bidding room;
for each bidder in the first subset of bidders:
publishing bid values of bids, in the second set of bids and received from each other bidder in the first subset of bidders, within the virtual private live-bidding room; and
for each bidder in the second subset of bidders:
excluding access to the virtual private live-bidding room; and
obfuscating bid values of bids in the second set of bids.

17. The method of claim 16:
further comprising accessing a tranche quantity of an asset tranche;
wherein receiving a bid, in the first set of bids, from a bidder in the first group of bidders during the blind-bidding period comprises:
for each bidder in a first group of bidders:
receiving a bid, in the first set of bids and comprising a first bid quantity and a first bid value, from the bidder;
wherein selecting the first subset of bidders comprises selecting the first subset of bidders, in the first group of bidders, associated with bids of greatest bid value, in the first set of bids, and totaling an aggregate quantity greater than the tranche quantity; and
wherein receiving the second set of bids from the first subset of bidders comprises:
for each bidder in the first subset of bidders:
receiving a bid, in the second set of bids and comprising a second bid quantity and a second bid value, from the bidder.

18. The method of claim 16:
wherein generating the set of digital access tokens for live-bidding comprises:
for each bidder in the first subset of bidders:
generating a security credential for a login session within the electronic bidding portal by the bidder;
wherein transmitting the set of live-bidding notifications to the first subset of bidders via the electronic bidding portal comprises:
for each bidder in the first subset of bidders:
transmitting a live-bidding notification, in the set of live-bidding notifications and containing a security credential in the set of digital access tokens, to the bidder;
wherein enabling bidding access by the first subset of bidders during the live-bidding period comprises:
for each bidder in the first subset of bidders:
enabling submission of bids during the live-bidding period in response to selection of a security credential, in the set of digital access tokens, by the bidder.

19. A method comprising:
accessing a first reserve value and a second reserve value;
activating a virtual public blind-bidding room;
during a blind-bidding period of a blind-bidding duration:
for each bidder in a first group of bidders:
receiving a bid, in a first set of bids, from the bidder via the virtual public blind-bidding room; and
obfuscating the first reserve value and bid values of bids, in the first set of bids and received from each other bidder in the first group of bidders, within the virtual public blind-bidding room;
in response to conclusion of the blind-bidding period:
selecting a first subset of bidders, in the first group of bidders, associated with bids of bid value greater than the first reserve value;
isolating a second subset of bidders in the first group of bidders and excluding the first subset of bidders;
generating a set of digital access tokens for live-bidding; and
assigning the set of digital access tokens to the first subset of bidders;
initializing a virtual private live-bidding room; and
during a live-bidding period succeeding the blind-bidding period:
enabling bidding access by the first subset of bidders within the virtual private live-bidding room based on association of the first subset of bidders to the set of digital access tokens;
receiving a second set of bids from the first subset of bidders via the virtual private live-bidding room;
for each bidder in the first subset of bidders:
publishing the second reserve value and bid values of bids, in the second set of bids and received from each other bidder in the first subset of bidders, within the virtual private live-bidding room; and
for each bidder in the second subset of bidders:
excluding access to the virtual private live-bidding room; and
obfuscating the second reserve value and bid values of bids in the second set of bids.

20. The method of claim 19:
wherein generating the set of digital access tokens for live-bidding comprises, for each bidder in the first subset of bidders:
generating a digital access token, in the set of digital access tokens, comprising a persistent security credential for a login session within the electronic bidding portal by the bidder;
wherein enabling bidding access by the first subset of bidders during the live-bidding period comprises, for each bidder in the first subset of bidders:
enabling entry into the virtual private live-bidding room via the electronic bidding portal during the live-bidding period in response to receipt of a digital access token, in the set of digital access tokens and comprising a persistent security credential, from the bidder; and
further comprising:
in response to conclusion of the live-bidding period, disabling submission of bids by the bidders in the first subset of bidders; and
for each bidder in the first subset of bidders:
enabling access to bid values of the second set of bids via the electronic biding platform in response to receipt of a digital access token, in the set of digital access tokens, from the bidder following the live bidding period.
